(19) United States
(12) Patent Application Publication
(10) Pub. No.: US 2022/0029840 A1
(43) Pub. Date: Jan. 27, 2022

(54) Resource Charging Method, MEC Management System, and MEC Host

(71) Applicant: Huawei Technologies Co., Ltd., Shenzhen (CN)

(72) Inventor: Jiangping Feng, Shenzhen (CN)

(21) Appl. No.: 17/450,478

(22) Filed: Oct. 11, 2021

Related U.S. Application Data
(63) Continuation of application No. PCT/CN2020/082022, filed on Mar. 30, 2020.

(30) Foreign Application Priority Data
Apr. 11, 2019 (CN) 201910289988.0

(51) Int. Cl. H04L 12/14; H04W 4/24

(52) U.S. Cl. CPC H04L 12/1403; H04W 4/24

(57) ABSTRACT

A method includes: a multi-access edge computing (MEC) management system receives resource usage information of a tenant sent by a MEC host, where the resource usage information is information about a resource consumed by a MEC application created by the tenant; and the MEC management system sends the resource usage information to a charging system device, where the resource usage information is used by the charging system device to charge the resource consumed by the MEC application of the tenant.

### CROSS-REFERENCE TO RELATED APPLICATIONS

This application is a continuation of International Application No. PCT/CN2020/082022, filed on Mar. 30, 2020, which claims priority to Chinese Patent Application No. 201910289988.0, filed on Apr. 11, 2019. The afore-mentioned patent applications are hereby incorporated by reference in their entireties.

### TECHNICAL FIELD

This application relates to the field of communications technologies, and in particular, to a resource charging method, a MEC management system, and a MEC host.

### BACKGROUND

Multi-access edge computing (MEC) provides services and cloud-computing functions required by a user nearby by using a radio access network. After the cloud-computing function is deployed at a network edge, a carrier-grade service environment with high performance, a low delay, and high bandwidth can be created. This accelerates download of content, services, and applications in a network, so that a consumer enjoys better network experience.

Currently, a MEC architecture includes two parts: a MEC host and a MEC management system. The MEC host includes a MEC platform, a virtualization infrastructure, and a MEC application. The MEC platform mainly includes functions such as service registration/discovery and a common service. The MEC management system includes a MEC orchestrator (multi-access edge computing orchestrator), a MEC platform manager (MEC platform manager), a virtualization infrastructure manager (virtualization infrastructure manager), and the like. The MEC orchestrator is configured to maintain an overall view of all mobile edge hosts, available resources, and available MEC services in the MEC system, and trigger application instantiation and termination. The MEC platform manager is configured to manage the MEC platform, a life cycle of the MEC application, and a flow rule and a DNS rule of the MEC application. The virtualization infrastructure manager manages a virtual resource required by the MEC application. In the architecture, a tenant creates an MEC application in the architecture through application instantiation, and invokes, by using the MEC application, a service resource provided in the MEC platform. In addition, a system resource of the system is consumed when the MEC application runs.

However, the current MEC architecture does not support charging for a resource used by the MEC application created by the tenant in the architecture.

### SUMMARY

Embodiments of this application provide a resource charging method, an information collection method, a MEC management system, and a MEC host, to charge a resource consumed by a MEC application of a tenant.

According to a first aspect, an embodiment of this application provides a resource charging method, including: a MEC management system receives resource usage information of a tenant sent by a MEC host, where the resource usage information is information about a resource consumed by a MEC application created by the tenant; and the MEC management system sends the resource usage information to a charging system device, where the resource usage information is used by the charging system device to charge the resource consumed by the MEC application of the tenant. Therefore, the MEC management system receives the resource usage information of the tenant sent by the MEC host, and sends the resource usage information to the charging system device. The charging system device charges, based on the resource usage information, the resource consumed by the MEC application of the tenant.

In a possible implementation of the first aspect, the resource usage information includes a type, a size, a quantity of times of usage, usage duration, a usage start time, and a usage end time of the resource. In the possible implementation, specific content included in the resource usage information is provided.

In another possible implementation of the first aspect, the type of the resource may be a service resource or a system resource, the service resource includes an application programming interface (API) that is provided by a MEC service and that is invoked by the MEC application, and the system resource includes a computing resource, a network resource, and/or a storage resource consumed when the MEC application runs. The resource usage information further includes a quantity of times that the MEC application invokes the API provided by the MEC service, and the quantity of times that the API is invoked is used by the charging system device to calculate, based on a preset API usage rate, a charging amount of a service resource used by the tenant. In the possible implementation, the specific type of the resource is provided, for example, the service resource or the system resource, and the service resource is the API provided by the MEC service.

In another possible implementation of the first aspect, before the MEC management system receives the resource usage information of the tenant sent by the MEC host, the method further includes: the MEC management system receives a charging policy of the tenant sent by a charging policy device; and the MEC management system sends an indication message to the MEC host, where the indication message carries the charging policy of the tenant. In the possible implementation, a mode in which the MEC management system obtains the charging policy is provided.

In another possible implementation of the first aspect, before the MEC management system receives the resource usage information of the tenant sent by the MEC host, the method further includes: the MEC management system obtains a charging policy of the tenant by using an application instantiation request message of the tenant; and the MEC management system sends an indication message to the MEC host, where the indication message carries the charging policy of the tenant. In the possible implementation, another mode in which the MEC management system obtains the charging policy is provided.

In another possible implementation of the first aspect, the charging policy indicates an online charging mode, the charging policy carries a usage rate of a resource used by the tenant, the usage rate is used by the MEC host to calculate a resource charging amount of the tenant, and before the MEC management system receives the resource usage information of the tenant sent by the MEC host, the method further includes: the MEC management system sends, to the MEC host, a first resource charging quota that the charging system device sets for the tenant; and that the MEC management system receives resource usage information of a tenant sent by a MEC host includes: when a resource charging difference between the resource charging amount of the tenant and the first resource charging quota is less than a preset threshold, the MEC management system receives the resource usage information of the tenant sent by the MEC host. In the possible implementation, a specific mode in which the MEC management system reports the resource usage information to the charging system device is provided.

In another possible implementation of the first aspect, after the MEC management system receives the resource usage information of the tenant sent by the MEC host, the method further includes: first, the MEC management system sends a request message to the MEC host, where the request message is a message that the MEC management system requests a resource charging quota for the tenant again; then, the MEC management system receives a second resource charging quota that the MEC host allocates to the tenant; and the MEC management system sends the second resource charging quota to the MEC host.

In another possible implementation of the first aspect, the charging policy indicates an offline charging mode, the charging policy carries a period in which the MEC host reports the resource usage information, and that the MEC management system receives resource usage information of a tenant sent by a MEC host includes: the MEC management system receives, based on the period, the resource usage information of the tenant sent by the MEC host.

According to a second aspect, an embodiment of this application provides a resource charging method, including: a MEC host collects resource usage information of a tenant, where the resource usage information is information about a resource consumed by a MEC application created by the tenant; and the MEC host sends the resource usage information to a MEC management system. Therefore, the MEC host collects the resource usage information of the tenant, so that when receiving the resource usage information, the MEC management system may forward the resource usage information to a charging system device, and the charging system device charges the resource consumed by the MEC application of the tenant.

In a possible implementation of the second aspect, the resource usage information includes a type, a size, a quantity of times of usage, usage duration, a usage start time, and a usage end time of the resource. In the possible implementation, specific content included in the resource usage information is provided.

In another possible implementation of the second aspect, the type of the resource may be a service resource or a system resource, the service resource includes an API that is provided by a MEC service and that is invoked by the MEC application, and the system resource includes a computing resource, a network resource, and/or a storage resource consumed when the MEC application runs; and the resource usage information includes a quantity of times that the MEC application invokes the API provided by the MEC service, and the quantity of times that the API is invoked is used by the charging system device to calculate, based on a preset API usage rate, a charging amount of a service resource used by the tenant. In the possible implementation, the specific type of the resource is provided, for example, the service resource or the system resource, and the service resource is the API provided by the MEC service.

In another possible implementation of the second aspect, before the MEC host collects the resource usage information of the tenant, the method further includes: the MEC host receives an indication message sent by the MEC management system, where the indication message carries a charging policy of the tenant, and the charging policy is used by the MEC host to report the resource usage information to the MEC management system. In the possible implementation, a mode in which the MEC host obtains the charging policy is provided.

In another possible implementation of the second aspect, the charging policy indicates an online charging mode, the charging policy carries a usage rate of a resource used by the tenant, and before the MEC host sends the resource usage information to the MEC management system, the method further includes: first, the MEC host receives a first resource charging quota that the charging system device sets for the tenant and that is sent by the MEC management system; then, the MEC host calculates, a resource charging amount of the tenant based on the resource usage information and the usage rate; and the MEC host compares the resource charging amount with the first resource charging quota, to obtain a resource charging difference; and that the MEC host sends resource usage information to a MEC management system includes: when the resource charging difference is less than or equal to a preset threshold, the MEC host sends the resource usage information to the MEC management system. In the possible implementation, a specific procedure in which the MEC host reports the resource usage information to the MEC management system in the online charging mode is provided.

In another possible implementation of the second aspect, after the MEC host sends the resource usage information to the MEC management system, the method further includes: the MEC host receives a second resource charging quota sent by the MEC management system, where the second resource charging quota is used by the MEC host to report the resource usage information of the tenant to the MEC management system again.

In another possible implementation of the second aspect, the charging policy indicates an offline charging mode, the charging policy carries a period in which the MEC host reports the resource usage information, and that the MEC host sends resource usage information to a MEC management system includes: the MEC host sends the resource usage information to the MEC management system based on the period. In the possible implementation, a specific procedure in which the MEC host reports the resource usage information to the MEC management system in the offline charging mode is provided.

According to a third aspect, an embodiment of this application provides a MEC management system. The MEC management system has a function of implementing behavior of the MEC management system in the first aspect, and the function may be implemented by hardware, or may be implemented by hardware executing corresponding software. The hardware or the software includes one or more modules corresponding to the foregoing function.

According to a fourth aspect, an embodiment of this application provides a MEC host. The MEC host has a function of implementing behavior of the MEC host in the second aspect, and the function may be implemented by hardware, or may be implemented by hardware executing corresponding software. The hardware or the software includes one or more modules corresponding to the foregoing function.

According to a fifth aspect, an embodiment of this application provides a MEC management system, and the MEC management system includes a processor, a memory, an input/output device, and a bus. The memory stores computer instructions, and when executing the computer instructions in the memory, the processor is configured to implement any implementation of the first aspect.

In a possible implementation of the fifth aspect, the processor, the memory, and the input/output device are separately connected to the bus.

According to a sixth aspect, an embodiment of this application provides a MEC host, and the MEC host includes a processor, a memory, an input/output device, and a bus. The memory stores computer instructions, when the processor executes the computer instructions in the memory, the memory stores the computer instructions, and when executing the computer instructions in the memory, the processor is configured to implement any implementation of the second aspect.

In a possible implementation of the sixth aspect, the processor, the memory, and the input/output device are separately connected to the bus.

According to a seventh aspect, an embodiment of this application provides a resource charging system, including the MEC management system in the third aspect and the MEC host in the fourth aspect.

According to an eighth aspect, an embodiment of this application provides a computer program product including instructions. When the computer program product is run on a computer, the computer is enabled to implement any implementation of the first aspect or the second aspect.

According to a ninth aspect, an embodiment of this application provides a computer-readable storage medium including instructions. When the instructions are run on a computer, the computer is enabled to implement any implementation of the first aspect or the second aspect.

It can be learned from the foregoing technical solutions that the embodiments of this application have the following advantages.

It can be learned from the foregoing solutions, the MEC management system receives the resource usage information of the tenant sent by the MEC host, where the resource usage information is the information about the resource consumed by the MEC application created by the tenant; and the MEC management system sends the resource usage information to the charging system device, so that the charging system device charges, based on the resource usage information, the resource consumed by the MEC application of the tenant. Therefore, in the technical solutions of this application, the MEC management system receives the resource usage information of the tenant sent by the MEC host, and sends the resource usage information to the charging system device. The charging system device charges, based on the resource usage information, the resource consumed by the MEC application of the tenant.

### BRIEF DESCRIPTION OF THE DRAWINGS

FIG. 1 is a diagram of a multi-access edge computing system architecture according to an embodiment of this application;

FIG. 2 is a schematic diagram of an embodiment of a resource charging method according to an embodiment of this application;

FIG. 3 is a schematic diagram of another embodiment of a resource charging method according to an embodiment of this application;

FIG. 4 is a schematic diagram of another embodiment of a resource charging method according to an embodiment of this application;

FIG. 5 is a schematic diagram of another embodiment of a resource charging method according to an embodiment of this application;

FIG. 6 is a schematic diagram of another embodiment of a resource charging method according to an embodiment of this application;

FIG. 7 is a schematic diagram of another embodiment of a resource charging method according to an embodiment of this application;

FIG. 8 is a schematic diagram of another embodiment of a resource charging method according to an embodiment of this application;

FIG. 9 is a schematic diagram of a structure of a MEC management system according to an embodiment of this application;

FIG. 10 is a schematic diagram of a structure of a MEC host according to an embodiment of this application;

FIG. 11 is a schematic diagram of another structure of a MEC management system according to an embodiment of this application;

FIG. 12 is a schematic diagram of another structure of a MEC host according to an embodiment of this application; and

FIG. 13 is a schematic diagram of a resource charging system according to an embodiment of this application.

### DETAILED DESCRIPTION OF ILLUSTRATIVE EMBODIMENTS

Embodiments of this application provide a resource charging method, a MEC management system, and a MEC host, to charge a resource consumed by a MEC application of a tenant.

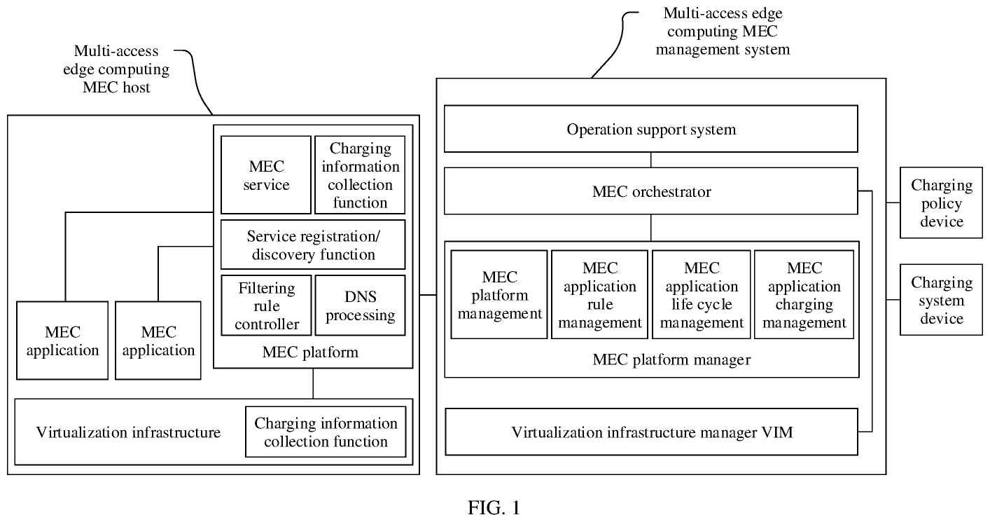

Refer to FIG. 1. FIG. 1 is a diagram of a multi-access edge computing system architecture according to this application. The system architecture mainly includes a MEC host, a MEC management system, a charging policy device, and a charging system device.

The MEC host includes a MEC platform, a MEC application, and a virtualization infrastructure. The MEC platform includes functions such as service registration/discovery, a common service (for example, a domain name service (DNS)), resource usage information collection, and filtering rule controlling. The resource usage information collection function is used to collect statistics on usage information of a service resource used when the MEC application created by a tenant invokes a MEC service of the MEC platform, and report, to the MEC management system, the usage information of the service resource used by the tenant, trace a usage condition of a service resource charging quota that the charging system device sets for the tenant, and the like. The tenant may be understood as a user creating the MEC application in the system architecture, for example, a personal user or an enterprise user. The virtualization infrastructure provides a system resource (for example, a computing resource, a storage resource, and a network resource) for the MEC application, and the virtualization infrastructure further collects usage information of the system resource consumed by the MEC application.

The MEC management system includes an operation support system (OSS), a MEC orchestrator, a MEC platform manager, and a virtualization infrastructure manager (VIM). The MEC platform manager includes a MEC platform management function, a MEC application rule management function, a MEC application life cycle management function, and a MEC application charging management function. The MEC application charging management function includes obtaining a resource charging quota of the tenant, collecting statistics on resource usage information of the tenant, tracing a usage condition of the resource charging quota of the tenant, periodically reporting the resource usage information of the tenant, and the like. In a possible implementation, the MEC platform manager is connected to the MEC platform in the MEC host, and the VIM is connected to the virtualization infrastructure in the MEC host.

The charging policy device is configured to store a charging policy of the tenant (for example, information such as charging by traffic, charging by duration, charging by a quantity of times that an API provided by the MEC service is invoked or no charging, a charging mode that is used to charge the tenant and that includes an online charging mode or an offline charging mode, a usage rate of the service resource of the MEC service provided by the MEC platform, and a usage rate of the system resource provided by the virtualization infrastructure), and interact with the OSS or the MEC orchestrator. The charging policy device may be connected to the OSS in the MEC management system, or the charging policy device may be connected to the MEC orchestrator. This is not specifically limited.

The charging system device is configured to: provide the resource charging quota for the tenant, charge, according to the charging policy of the tenant that is preset by the charging system device, a resource used by the tenant, and generate a charging data record. The charging system device is separately connected to the MEC platform manager and the VIM in the MEC management system. Optionally, the charging system device is connected to the MEC orchestrator, and is configured to obtain the charging policy of the tenant by using the MEC orchestrator.

It should be noted that the charging policy device in FIG. 1 may alternatively be integrated into the multi-access edge computing management system. This is not specifically limited in this application. In addition, the OSS, the MEC orchestrator, the MEC platform manager, and the VIM included in the multi-access edge computing management system may be integrated into one device as shown in FIG. 1, or may be a plurality of separate modules. This is not specifically limited in this application.

In addition, the system architecture shown in FIG. 1 shows only one MEC host (the MEC host includes the MEC platform) and one virtualization infrastructure. In an actual application, the system architecture may include a plurality of MEC hosts, and each MEC host may include one MEC platform and one virtualization infrastructure. The plurality of MEC hosts report usage information of service resources of MEC services invoked by MEC applications of different MEC platforms and system resources consumed by the MEC applications, so that the MEC management system may collect statistics on the service resources and the system resources that are used by the MEC applications and that are reported by the plurality of MEC hosts.

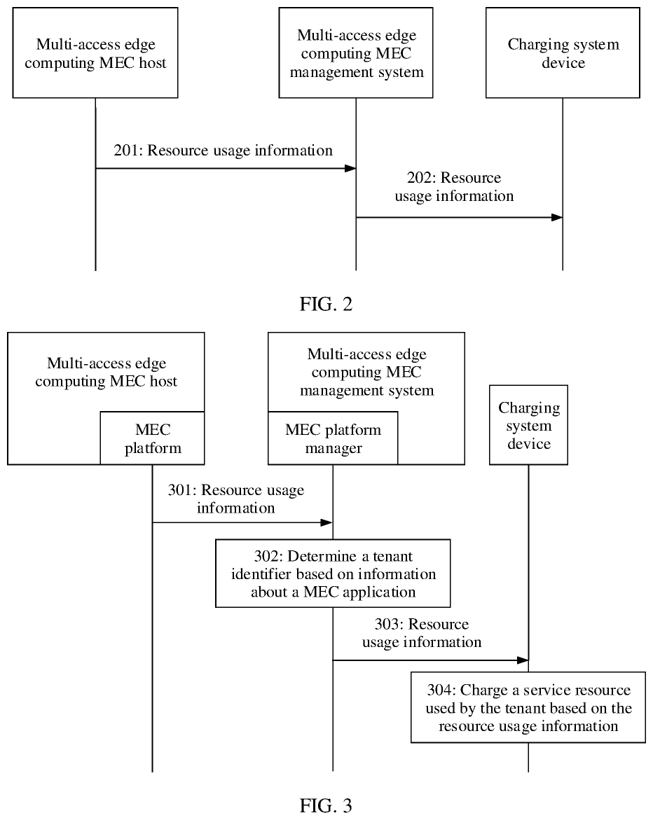

The following describes a resource charging method according to an embodiment of this application from a perspective of an MEC management system. Refer to FIG. 2. An embodiment of the resource charging method in this embodiment of this application includes the following steps.

201: A MEC management system receives resource usage information sent by a MEC host.

The resource usage information is information about a resource consumed by a MEC application created by a tenant. Optionally, the resource usage information includes a type of the resource, a size of the resource, a quantity of times that and duration in which the MEC application uses the resource, a usage start time of the resource, and a usage end time of the resource. The type of the resource may be a service resource or a system resource, the service resource includes an API that is provided by a MEC service and that is invoked by the MEC application, and the system resource includes a computing resource, a network resource, and/or a storage resource consumed when the MEC application runs.

For example, in the multi-access edge computing system architecture shown in FIG. 1, the tenant creates the MEC application through application instantiation, and then the MEC application invokes the API provided by the MEC service of the MEC platform in the MEC host. To be specific, the service resource is consumed when the MEC application invokes the MEC service, and the service resource is the API provided by the MEC service. In addition, when the MEC application runs, the system resource (for example, the computing resource, the storage resource, and the network resource) of the system may be consumed. In this case, the MEC management system collects the resource usage information of the resource consumed by the MEC application of the tenant. For example, the resource usage information includes a quantity of times that the MEC application invokes the API provided by the MEC service in preset duration.

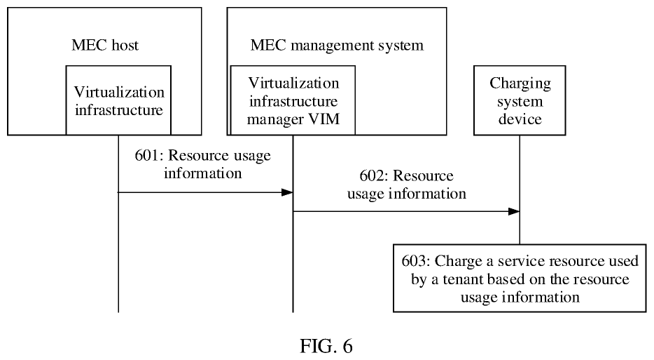

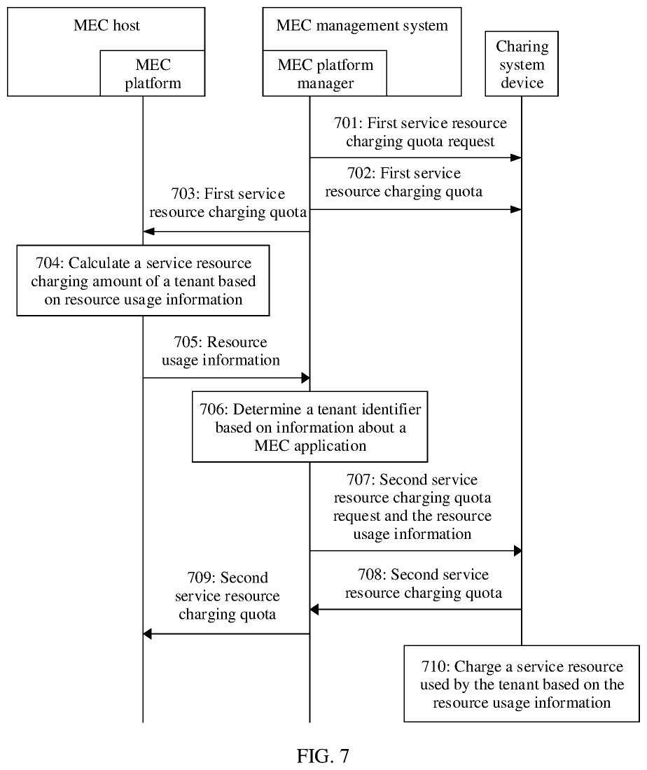

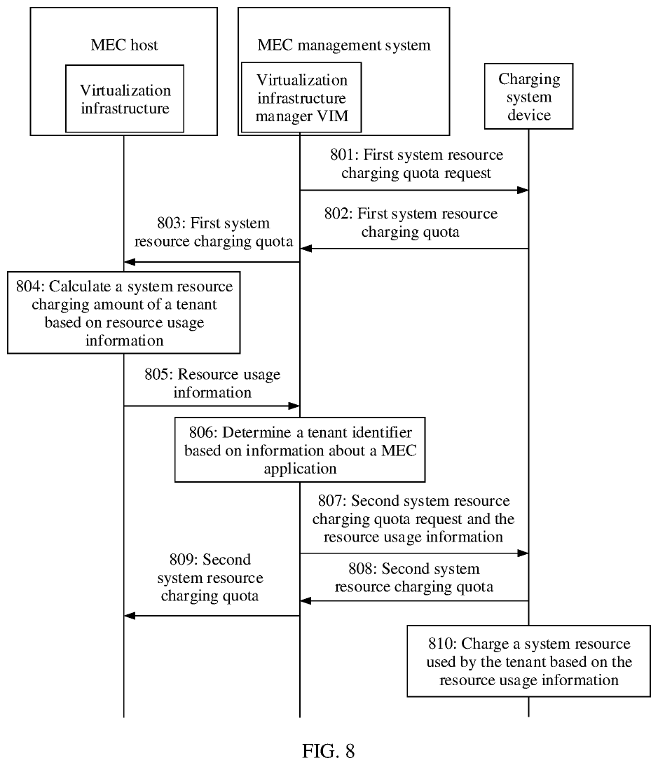

In this embodiment, the MEC host collects the resource usage information of the tenant, and then reports the resource usage information to the MEC management system. A specific reporting mode is determined by a charging policy corresponding to the tenant, and the charging policy may include an online charging mode or an offline charging mode. Specifically, that the MEC host reports the resource usage information in the two charging modes is described in detail in an embodiment shown in FIG. 3, an embodiment shown in FIG. 6, an embodiment shown in FIG. 7, and an embodiment shown in FIG. 8.

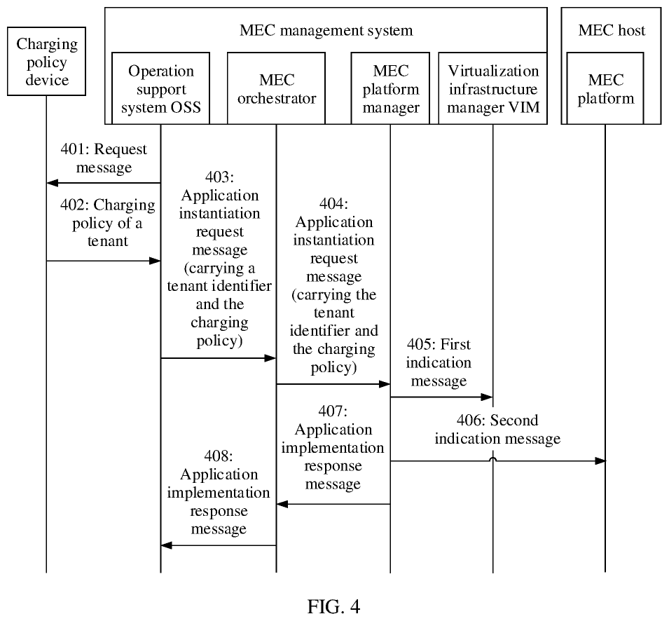

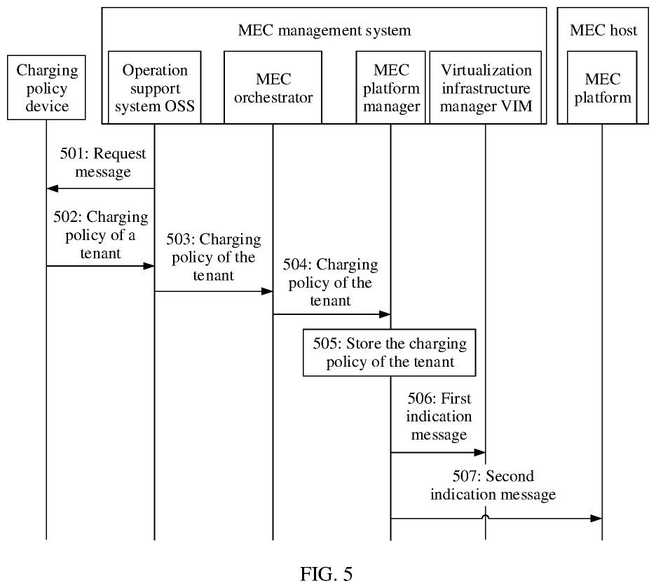

It should be noted that the charging policy may be delivered by the MEC management system to the MEC host, and may be specifically delivered by using an application instantiation request initiated by the tenant, or may be delivered by the MEC management system to the MEC host by using an independent procedure. This is not specifically limited in this application. For a specific process, refer to detailed description in an embodiment shown in FIG. 4 and an embodiment shown in FIG. 5.

202: The MEC management system sends the resource usage information to a charging system device.

The MEC management system sends the resource usage information to the charging system device. Then, the charging system device calculates a resource charging amount of the tenant based on the resource usage information, and generates a charging data record. For example, the resource usage information includes the quantity of times that the MEC application of the tenant invokes the API provided by the MEC service, and the charging system device calculates the resource charging amount of the tenant based on a preset API usage rate and the quantity of times that the API is invoked, where the API usage rate is an expense required each time the tenant invokes the API provided by the MEC service.

In this embodiment of this application, the MEC management system receives the resource usage information of the tenant sent by the MEC host, where the resource usage information is information about the resource consumed by the MEC application created by the tenant; and the MEC management system may send the resource usage information to the charging system device, so that the charging system device charges, based on the resource usage information, the resource consumed by the MEC application of the tenant. Therefore, in the technical solution of this application, the MEC management system receives the resource usage information of the tenant sent by the MEC host, and sends the resource usage information to the charging system device. The charging system device charges, based on the resource usage information, the resource consumed by the MEC application of the tenant.

With reference to a specific embodiment, the following describes the offline charging mode and the online charging mode in step 201 in FIG. 2.

FIG. 3 is a schematic diagram of a resource charging method according to an embodiment of this application. In FIG. 3, a MEC host reports resource usage information of a tenant in an offline charging mode indicated by a charging policy. Refer to FIG. 3. The method includes the following steps.

301: The MEC host sends the resource usage information of the tenant to a MEC management system by using a MEC platform.

The resource usage information includes information about a MEC application, for example, an identifier of the MEC application. The resource usage information includes a type, a size, usage duration, a usage start time, a usage end time, and the like of a resource.

In this embodiment, a charging policy of the tenant indicates to charge, in the offline charging mode, a service resource consumed by the tenant, and the charging policy carries a period in which the MEC host reports the resource usage information of the tenant. The MEC host sends, based on the period carried in the charging policy, the resource usage information of the service resource used by the tenant to the MEC management system by using the MEC platform. The service resource includes an API that is provided by a MEC service and that is invoked by the MEC application, and the like. The resource usage information includes a quantity of times that the MEC application invokes the API provided by the MEC service, duration in which the MEC application invokes the MEC service, or the like.

In this embodiment, before the MEC host reports the resource usage information of the tenant to the MEC management system, the MEC management system delivers the charging policy to the MEC host, so that the MEC host reports the resource usage information to the MEC management system in a corresponding mode. The charging policy may be delivered in a plurality of modes. The following describes the modes by using an example.

1. The charging policy is delivered during application instantiation of the tenant. To be specific, an application instantiation request initiated by the tenant carries the charging policy of the tenant.

2. The MEC management system delivers the charging policy of the tenant by using an independent procedure.

The following describes in detail the two possible delivery modes by using specific embodiments.

Refer to FIG. 4. FIG. 4 is a process in which a MEC management system delivers a charging policy of a tenant to a MEC host during tenant application instantiation. A specific process includes the following steps.

401: An OSS in the MEC management system sends a request message to a charging policy device.

The request message is used by the OSS to request the charging policy of the tenant from the charging policy device, and the request message carries a tenant identifier of the tenant.

402: The OSS in the MEC management system receives the charging policy of the tenant sent by the charging policy device.

The charging policy device determines the corresponding charging policy based on the tenant identifier of the tenant carried in the request message, and then sends the charging policy of the tenant to the OSS. The charging policy is used to indicate an online charging mode or an offline charging mode. When the charging policy of the tenant indicates the online charging mode, the charging policy includes a usage rate of a service resource and a usage rate of a system resource. When the charging policy indicates the offline charging mode, the charging policy includes a period in which the MEC host reports the resource usage information of the tenant. In addition, charging modes corresponding to different types of resources of a same tenant may be different, and the MEC host may be notified of a specific charging mode by using the charging policy. For example, for a service resource used by the tenant, the charging policy indicates to charge the service resource in the offline charging mode, and indicates the MEC host to report resource usage information of the service resource once an hour. For a system resource consumed by a MEC application of the tenant, the charging policy indicates to charge the system resource in the online charging mode, and carries a usage rate of the system resource and the like.

It should be noted that, as shown in FIG. 1, when the charging policy device is directly connected to the OSS in the MEC management system, the OSS may directly request the charging policy of the tenant from the charging policy device, and then the OSS directly receives the charging policy of the tenant sent by the charging policy device. When the charging policy device is directly connected to the MEC orchestrator in the MEC management system, the OSS requests the charging policy of the tenant from the charging policy device by using the MEC orchestrator, and then the OSS receives, by using the MEC orchestrator, the charging policy of the tenant sent by the charging policy device. Specifically, how the OSS obtains the charging policy of the tenant is determined based on an actual connection relationship between the charging policy device and the MEC management system. This is not limited in this application.

403: The MEC management system receives, by using the MEC orchestrator, an application instantiation request message sent by the OSS in the MEC management system.

The application instantiation request message carries the tenant identifier and the charging policy of the tenant.

404: The MEC management system sends the application instantiation request message to a MEC platform manager in the MEC management system by using the MEC orchestrator.

405: The MEC management system sends a first indication message to a VIM by using the MEC platform manager.

The MEC platform manager determines, based on the application instantiation request message, a charging policy for the system resource used by the tenant, and then the MEC platform manager sends the first indication message to the VIM. The first indication message carries the charging policy for the system resource, and is used by the VIM to set the charging policy for the tenant.

406: The MEC management system sends a second indication message to a MEC platform in the MEC host by using the MEC platform manager.

The MEC platform manager determines, based on the application instantiation request message, a charging policy for the service resource used by the tenant, and then the MEC platform manager sends the second indication message to the MEC platform in the MEC host. The second indication message carries the charging policy for the service resource, and is used by the MEC platform to set the charging policy for the tenant.

407: The MEC management system sends an application instantiation response message to the MEC orchestrator in the MEC management system by using the MEC platform manager.

The application instantiation response message is used to notify the OSS that application instantiation of the MEC application is completed.

408: The MEC management system sends the application instantiation response message to the OSS in the MEC management system by using the MEC orchestrator.

Refer to FIG. 5. FIG. 5 is a process in which a MEC management system delivers a charging policy of a tenant by using an independent procedure. A specific process includes the following steps.

501: An OSS in the MEC management system sends a request message to a charging policy device.

502: The OSS in the MEC management system receives the charging policy of the tenant sent by the charging policy device.

Step 501 and step 502 are similar to step 401 and step 402 in FIG. 4. Details are not described herein again.

503: The MEC management system sends the charging policy of the tenant to a MEC orchestrator in the MEC management system by using the OSS.

504: The MEC management system sends the charging policy of the tenant to a MEC platform manager in the MEC management system by using the MEC orchestrator.

505: The MEC management system stores the charging policy of the tenant by using the MEC platform manager.

When receiving the charging policy of the tenant, the MEC platform manager stores the charging policy of the tenant.

506: The MEC platform manager in the MEC management system sends a first indication message to a VIM in the MEC management system.

The first indication message carries a charging policy for a system resource of the tenant, and is used by the VIM to set the charging policy for the tenant.

507: The MEC platform manager in the MEC management system sends a second indication message to a MEC platform in a MEC host.

The second indication message carries a charging policy for a service resource of the tenant, and is used by the MEC platform to set the charging policy for the tenant.

For example, in the embodiment shown in FIG. 5, the charging policy may be delivered by using the independent procedure during application instantiation. To be specific, in a mode in which the MEC management system delivers the charging policy by using the independent procedure, when the MEC platform manager receives an application instantiation request message, the MEC platform manager may first determine whether a charging policy of the tenant corresponding to a tenant identifier carried in the application instantiation request message exists locally. If the charging policy of the tenant exists, the MEC management system does not need to request the charging policy from the charging policy device, and directly performs step 505 to step 507, in other words, step 501 to step 504 are not performed. If the charging policy of the tenant does not exist, the MEC management system performs the procedure shown in FIG. 5.

302: The MEC management system determines the tenant identifier of the tenant based on information about the MEC application by using the MEC platform manager.

The resource usage information includes the information about the MEC application. For example, it can be learned from the embodiment in FIG. 4 that the application instantiation request carries the tenant identifier of the tenant, and the MEC platform manager determines a correspondence between the MEC application, the tenant identifier, and the charging policy of the tenant. Therefore, the MEC platform manager may determine the tenant identifier of the tenant based on the information about the MEC application carried in the resource usage information.

303: The MEC management system sends the resource usage information to a charging system device by using the MEC platform manager.

The MEC platform manager sends, to the charging system device, the resource usage information of the service resource used by the tenant. It should be noted that, when there are a plurality of MEC platforms in the system architecture, the MEC platform manager receives resource usage information that is of service resources used by MEC applications of the tenant and that is sent by the plurality of MEC platforms. In this case, the MEC platform manager needs to collect statistics on the resource usage information of the tenant reported by the plurality of MEC platforms, to subsequently report, to the charging system device, the resource usage information of the service resources used by the MEC applications of the tenant in a period, so that the charging system device charges the service resources used by the tenant.

304: The charging system device charges, based on the resource usage information, the service resource used by the tenant.

For example, the charging system device charges the tenant based on the resource usage information and a usage rate of the service resource that is preset by the charging system device. The usage rate of the service resource may be determined based on a level of the tenant. For example, a VIP tenant has a lower usage rate than a common tenant. Alternatively, all tenants may use a same usage rate. This is not specifically limited in this application. For example, the resource usage information includes a quantity of times that the MEC application of the tenant invokes an API provided by a MEC service. The charging system device determines a usage rate at which the tenant invokes the API provided by the MEC service once, and then multiplies the usage rate by the quantity of times that the MEC application invokes the API provided by the MEC service, to obtain a charging amount of the tenant.

In this embodiment, in the system architecture, the system resource consumed by the tenant may alternatively be charged in an offline charging mode. A specific charging process is similar to a process of charging the service resource used by the tenant. The following provides description by using an embodiment shown in FIG. 6. Refer to FIG. 6. The method includes the following steps.

601: A MEC host sends resource usage information of a system resource of the tenant to a VIM in a MEC management system by using a virtualization infrastructure.

The resource usage information includes information about a MEC application, for example, an identifier of the MEC application. The resource usage information includes a type, a size, usage duration, a usage start time, a usage end time, and the like of the resource.

In this embodiment, the MEC host determines, based on a charging policy delivered by the MEC management system, that a charging system device charges the system resource used by the tenant in an offline charging mode. To be specific, the charging policy indicates the offline charging mode, and carries a period in which the MEC host reports the resource usage information of a service resource of the tenant. For specific delivery of the charging policy, refer to the embodiments shown in FIG. 4 and FIG. 5. Details are not described herein again. The MEC host collects the resource usage information of the system resource consumed when the MEC application of the tenant runs. For example, the system resource includes a computing resource, a storage resource, and a network resource consumed when the MEC application runs, and the resource usage information includes usage duration of the system resource when the MEC application runs. Then, the MEC host sends, based on the period indicated in the charging policy, the resource usage information of the system resource consumed by the MEC application of the tenant to the VIM in the MEC management system by using the virtualization infrastructure.

602: The MEC management system sends the resource usage information to the charging system device by using the VIM.

It should be noted that, when there are a plurality of MEC platforms in the system architecture, each MEC platform corresponds to one virtualization infrastructure. When receiving resource usage information that is of system resources consumed by MEC applications of the tenant and that is sent by a plurality of virtualization infrastructures, the VIM collects statistics on the resource usage information reported by the plurality of virtualization infrastructures, to determine the resource usage information of the system resources used by the tenant in the period, so that the charging system device charges the system resources used by the tenant.

603: The charging system device charges, based on the resource usage information, the system resource used by the tenant.

For example, the charging system device charges the system resource used by the tenant based on the resource usage information and a usage rate of the system resource that is preset by the charging system device. The usage rate of the system resource may be determined based on a level of the tenant. For example, a VIP tenant has a lower usage rate than a common tenant. Alternatively, all tenants may use a same usage rate. This is not specifically limited in this application.

For example, the resource usage information includes the usage duration of the system resource used by the MEC application of the tenant. The charging system device may determine a usage rate at which the tenant uses the system resource each hour, and then multiplies the usage rate by the usage duration of the system resource used by the MEC application, to obtain a charging amount of the tenant. For another example, the resource usage information further includes a size of the system resource used by the MEC application. Then, the charging system device determines a usage rate at which each time the tenant uses each megabit of system resource, and multiplies the usage rate by the size of the system resource used by the MEC application, to obtain a charging amount of the tenant.

In this embodiment of this application, the MEC management system receives the resource usage information of the tenant sent by the MEC host, where the resource usage information is information about the resource consumed by the MEC application created by the tenant; and then the MEC management system sends the resource usage information to the charging system device, so that the charging system device charges, based on the resource usage information, the resource consumed by the MEC application of the tenant. Therefore, in the technical solution of this application, the MEC management system receives the resource usage information of the tenant sent by the MEC host, and sends the resource usage information to the charging system device. The charging system device charges, based on the resource usage information, the resource consumed by the MEC application of the tenant.

FIG. 7 is a schematic diagram of a resource charging method according to an embodiment of this application. In FIG. 7, a MEC host reports, in an online charging mode, resource usage information of a service resource consumed by a MEC application of a tenant, so that a charging system device charges, in the online charging mode, the service resource consumed by the tenant. Refer to FIG. 7. The method includes the following steps.

701: A MEC management system sends a first service resource charging quota request of the tenant to a charging system device by using a MEC platform manager.

The MEC management system determines that a charging policy of the tenant indicates the online charging mode, and the MEC management system sends the first service resource charging quota request of the tenant to the charging system device by using the MEC platform manager.

702: The MEC management system receives, by using the MEC platform manager, a first service resource charging quota sent by the charging system device.

The MEC platform manager receives the first service resource charging quota that the charging system device sets for the tenant.

703: The MEC management system sends the first service resource charging quota to a MEC platform in a MEC host by using the MEC platform manager.

It should be noted that the MEC platform manager may deliver the first service resource charging quota to the MEC platform and the charging policy simultaneously, or may first deliver the charging policy and then deliver the first service resource charging quota to the MEC platform. This is not specifically limited herein.

704: The MEC host calculates a service resource charging amount of the tenant based on the resource usage information by using the MEC platform.

It can be learned from the foregoing embodiments in FIG. 4 and FIG. 5 that before the MEC host reports the resource usage information of the tenant, the MEC management system delivers the charging policy to the MEC host, where the charging policy carries a usage rate of the service resource used by the tenant, for example, an expense corresponding to each time the MEC application of the tenant invokes an API provided by a MEC service, or an expense corresponding to a service resource used by the MEC application of the tenant each hour, so that the MEC host may report the resource usage information of the tenant according to the charging policy. The MEC host collects, by using the MEC platform, the resource usage information of the service resource consumed when the MEC application of the tenant invokes the MEC service. Then, the MEC platform calculates the service resource charging amount of the tenant based on the resource usage information of the service resource of the tenant and the usage rate of the service resource used by the tenant.

For example, the resource usage information includes a quantity of times that the MEC application of the tenant invokes the API provided by the MEC service. Then, the MEC platform in the MEC host determines a usage rate at which the API is invoked once, and multiplies the usage rate by the quantity of times that the API is invoked, to obtain the service resource charging amount. For another example, the resource usage information includes usage duration of the service resource used by the tenant. The MEC platform determines a usage rate corresponding to a service resource used by the tenant each hour, and multiplies the usage duration by the usage rate, to obtain the service resource charging amount of the tenant.

705: When a service resource charging difference between the service resource charging amount and the first service resource charging quota is less than a preset threshold, the MEC host sends the resource usage information of the service resource of the tenant to the MEC platform manager in the MEC management system by using the MEC platform.

The MEC platform determines the service resource charging difference based on the service resource charging amount and the first service resource charging quota that the charging system device sets for the tenant. When the service resource charging difference is less than the preset threshold, the MEC platform sends the resource usage information of the service resource of the tenant to the MEC platform manager in the MEC management system.

706: The MEC management system determines a tenant identifier of the tenant based on information about the MEC application by using the MEC platform manager.

Step 706 is similar to step 302 in FIG. 3. Details are not described herein again. When receiving the resource usage information sent by the MEC host, the MEC management system may determine that the first service resource charging quota of the tenant is about to be exhausted.

707: The MEC management system sends a second service resource charging quota request and the resource usage information to the charging system device by using the MEC platform manager.

The MEC platform manager generates the second service resource charging quota request for the tenant, and sends the second service resource charging quota request and the resource usage information of the service resource of the tenant to the charging system device. The second service resource charging quota request is used by the MEC management system to request the charging system device to allocate a new service resource charging quota to the tenant.

708: The MEC management system receives, by using the MEC platform manager, a second service resource charging quota sent by the charging system device.

The charging system device allocates the second service resource charging quota to the tenant based on the second service resource charging quota request, and sends the second service charging quota to the MEC platform manager in the MEC management system.

709: The MEC management system sends the second service resource charging quota to the MEC host by using the MEC platform manager.

The MEC platform manager sends the second service resource charging quota to the MEC platform in the MEC host, where the second service resource charging quota is used by the MEC platform to set the second service resource charging quota for the tenant. Therefore, in duration of a next period, when a service resource charging difference between the service resource charging amount of the tenant and the second service resource charging quota is less than the preset threshold, the MEC platform reports the resource usage information of the service resource of the tenant to the MEC platform manager again.

710: The charging system device charges, based on the resource usage information, the service resource used by the tenant.

Step 703 is similar to step 304 in FIG. 3. Details are not described herein again.

In this embodiment, in the system architecture, a system resource consumed by the tenant may alternatively be charged in the online charging mode. A specific charging process is similar to a process of charging the service resource used by the tenant. The following provides description by using an embodiment shown in FIG. 8. Refer to FIG. 8. The method includes the following steps.

801: A MEC management system sends a first system resource charging quota request to a charging system device by using a VIM.

The MEC management system determines that a charging policy of the tenant indicates an online charging mode, and the MEC management system may send the first system resource charging quota request of the tenant to the charging system device by using a MEC platform manager.

802: The MEC management system receives, by using the VIM, a first system resource charging quota sent by the charging system device.

The VIM receives the first system resource charging quota that the charging system device sets for the tenant.

803: The MEC management system sends the first system resource charging quota to a virtualization infrastructure in a MEC host by using the VIM.

It should be noted that the MEC platform manager may deliver the first system resource charging quota to a MEC platform and the charging policy simultaneously, or may first deliver the charging policy and then deliver the first service resource charging quota to the MEC host. This is not specifically limited in this application.

804: The MEC host calculates a system resource charging amount of the tenant based on resource usage information by using the virtualization infrastructure.

It can be learned from the foregoing embodiments in FIG. 4 and FIG. 5 that before the MEC host reports the resource usage information of the tenant, the MEC management system delivers the charging policy to the MEC host, where the charging policy carries a usage rate of a system resource used by the tenant, for example, an expense corresponding to a system resource used by a MEC application of the tenant each hour, or an expense corresponding to each megabit of system resource used by a MEC application of the tenant, so that the MEC host reports the resource usage information of the system resource used by the tenant in the online charging mode. The virtualization infrastructure in the MEC host collects the resource usage information of the system resource used when the MEC application of the tenant runs, and the virtualization infrastructure calculates the system resource charging amount of the tenant based on the resource usage information and the usage rate that is of the system resource used by the tenant and that is indicated by the charging policy.

805: When a difference between the system resource charging amount and the first system resource charging quota is less than a preset threshold, the MEC host sends the resource usage information of the system resource of the tenant to the VIM in the MEC management system by using the virtualization infrastructure.

The virtualization infrastructure determines the system resource charging difference based on the system resource charging amount and the first system resource charging quota that the charging system device allocates for the tenant. When the system resource charging difference is less than the preset threshold, the virtualization infrastructure sends the resource usage information of the system resource of the tenant to the VIM in the MEC management system.

806: The MEC management system determines, by using the VIM, a tenant identifier of the tenant based on information about the MEC application carried in the resource usage information.

807: The MEC management system sends a second system resource charging quota request and the resource usage information of the system resource used by the tenant to the charging system device by using the VIM.

808: The charging system device sends a second system resource charging quota to the VIM in the MEC management system.

809: The MEC management system sends the second system resource charging quota to the virtualization infrastructure in the MEC host by using the VIM.

810: The charging system device charges, based on the resource usage information, the system resource used by the tenant.

Step 806 to step 810 are similar to step 706 to step 710 in FIG. 7. Details are not described herein again.

In this embodiment of this application, the MEC management system receives the resource usage information of the tenant sent by the MEC host, where the resource usage information is information about the resource consumed by the MEC application created by the tenant; and then the MEC management system sends the resource usage information to the charging system device, so that the charging system device charges, based on the resource usage information, the resource consumed by the MEC application of the tenant. Therefore, in the technical solution of this application, the MEC management system receives the resource usage information of the tenant sent by the MEC host, and sends the resource usage information to the charging system device. The charging system device charges, based on the resource usage information, the resource consumed by the MEC application of the tenant.

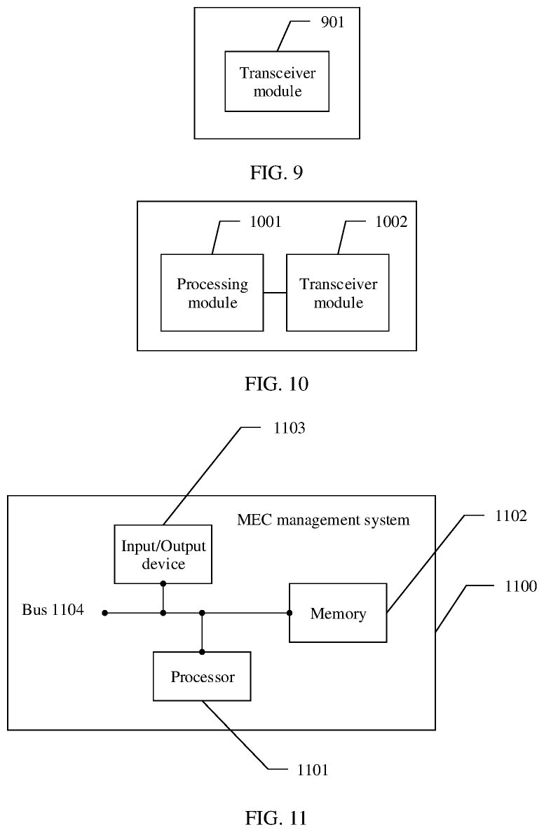

The following describes a MEC management system according to an embodiment of this application. FIG. 9 shows an embodiment of a MEC management system according to an embodiment of this application. The MEC management system may be configured to perform steps performed by the MEC management system in the embodiments shown in FIG. 2, FIG. 3, FIG. 4, FIG. 5, FIG. 6, FIG. 7, and FIG. 8. For details, refer to related description in the foregoing method embodiments.

The MEC management system includes a transceiver module 901.

The transceiver module 901 is configured to receive resource usage information of a tenant sent by a MEC host, where the resource usage information is information about a resource consumed by a MEC application created by the tenant.

The transceiver module 901 is configured to send the resource usage information to a charging system device, where the resource usage information is used by the charging system device to charge the resource consumed by the MEC application of the tenant.

In a possible implementation, the resource usage information includes a type, a size, a quantity of times of usage, usage duration, a usage start time, and a usage end time of the resource.

In another possible implementation, the type of the resource may be a service resource or a system resource, the service resource includes an API that is provided by a MEC service and that is invoked by the MEC application, and the system resource includes a computing resource, a network resource, and/or a storage resource consumed when the MEC application runs. The resource usage information includes a quantity of times that the MEC application invokes the API provided by the MEC service, and the quantity of times that the API is invoked is used by the charging system device to calculate, based on a preset API usage rate, a charging amount of a service resource used by the tenant.

In another possible implementation, the transceiver module 901 is further configured to: receive a charging policy of the tenant sent by a charging policy device; and send an indication message to the MEC host, where the indication message carries the charging policy of the tenant.

In another possible implementation, the transceiver module 901 is further configured to: obtain a charging policy of the tenant by using an application instantiation request message of the tenant; and send an indication message to the MEC host, where the indication message carries the charging policy of the tenant.

In another possible implementation, the charging policy indicates an online charging mode, the charging policy carries a usage rate of a resource used by the tenant, and the usage rate is used by the MEC host to calculate a resource charging amount of the tenant. The transceiver module 901 is further configured to: send, to the MEC host, a first resource charging quota that the charging system device sets for the tenant.

The transceiver module 901 is specifically configured to: when a resource charging difference between the resource charging amount of the tenant and the first resource charging quota is less than a preset threshold, receive the resource usage information of the tenant sent by the MEC host.

In another possible implementation, the transceiver module 901 is further configured to: send a request message to the MEC host, where the request message is a message that the MEC management system requests a resource charging quota for the tenant again; receive a second resource charging quota that the MEC host allocates to the tenant; and send the second resource charging quota to the MEC host.

In another possible implementation, the charging policy indicates an offline charging mode, and the charging policy carries a period in which the MEC host reports the resource usage information. The transceiver module 901 is specifically configured to: receive, based on the period, the resource usage information of the tenant sent by the MEC host.

In this embodiment of this application, the transceiver module 901 receives the resource usage information of the tenant sent by the MEC host, where the resource usage information is information about the resource consumed by the MEC application created by the tenant; and the transceiver module 901 sends the resource usage information to the charging system device, so that the charging system device charges, based on the resource usage information, the resource consumed by the MEC application of the tenant. Therefore, in the technical solution of this application, the transceiver module 901 receives the resource usage information of the tenant sent by the MEC host, and sends the resource usage information to the charging system device. The charging system device charges, based on the resource usage information, the resource consumed by the MEC application of the tenant.

The following describes a MEC host according to an embodiment of this application. FIG. 10 shows an embodiment of a MEC host according to an embodiment of this application. The MEC host may be configured to perform steps performed by the MEC host in the embodiments shown in FIG. 2, FIG. 3, FIG. 4, FIG. 5, FIG. 6, FIG. 7, and FIG. 8. For details, refer to related description in the foregoing method embodiments.

The MEC host includes a processing module 1001 and a transceiver module 1002.

The processing module 1001 is configured to collect resource usage information of a tenant, where the resource usage information is information about a resource consumed by a MEC application created by the tenant.

The transceiver module 1002 is configured to send the resource usage information to a MEC management system, so that the MEC management system sends the resource usage information to a charging system device, and the charging system device charges the resource used by the tenant.

In a possible implementation, the resource usage information includes a type, a size, a quantity of times of usage, usage duration, a usage start time, and a usage end time of the resource.

In another possible implementation, the type of the resource may be a service resource or a system resource, the service resource includes an API that is provided by a MEC service and that is invoked by the MEC application, and the system resource includes a computing resource, a network resource, and/or a storage resource consumed when the MEC application runs; and the resource usage information includes a quantity of times that the MEC application invokes the API provided by the MEC service, and the quantity of times that the API is invoked is used by the charging system device to calculate, based on a preset API usage rate, a charging amount of a service resource used by the tenant.

In another possible implementation, the transceiver module 1002 is further configured to: receive an indication message sent by the MEC management system, where the indication message carries a charging policy of the tenant, and the charging policy is used by the transceiver module 1002 to report the resource usage information to the MEC management system.

In another possible implementation, the charging policy indicates an online charging mode, and the charging policy carries a usage rate of a resource used by the tenant. The transceiver module 1002 is further configured to: receive a first resource charging quota that the charging system device sets for the tenant and that is sent by the MEC management system.

The processing module 1001 is further configured to: calculate a resource charging amount of the tenant based on the resource usage information and the usage rate; and compare the resource charging amount with the first resource charging quota, to obtain a resource charging difference.

The processing module 1001 is specifically configured to: when the resource charging difference is less than or equal to a preset threshold, send the resource usage information to the MEC management system.

In another possible implementation, the transceiver module 1002 is further configured to: receive a second resource charging quota sent by the MEC management system, where the second resource charging quota is used by the transceiver module 1002 to report the resource usage information of the tenant to the MEC management system again.

In another possible implementation, the charging policy indicates an offline charging mode, and the charging policy carries a period in which the MEC host reports the resource usage information. The transceiver module 1002 is specifically configured to: send the resource usage information to the MEC management system based on the period.

In this embodiment of this application, the processing module 1001 collects the resource usage information of the tenant, and the transceiver module 1002 sends the resource usage information to the MEC management system, so that when receiving the resource usage information, the MEC management system may forward the resource usage information to the charging system device, and the charging system device charges the resource consumed by the MEC application of the tenant.

This application further provides a MEC management system 1100. FIG. 11 shows an embodiment of a MEC management system according to an embodiment of this application. The MEC management system may be configured to perform steps performed by the MEC management system in the embodiments shown in FIG. 2, FIG. 3, FIG. 4, FIG. 5, FIG. 6, FIG. 7, and FIG. 8. For details, refer to related description in the foregoing method embodiments.

The MEC management system 1100 includes a processor 1101, a memory 1102, an input/output device 1103, and a bus 1104.

In a possible implementation, the processor 1101, the memory 1102, and the input/output device 1103 are separately connected to the bus 1104, and the memory stores computer instructions.

The transceiver module 901 in the foregoing embodiment may be specifically the input/output device 1103 in this embodiment. Therefore, a specific implementation of the input/output device 1103 is not described again.

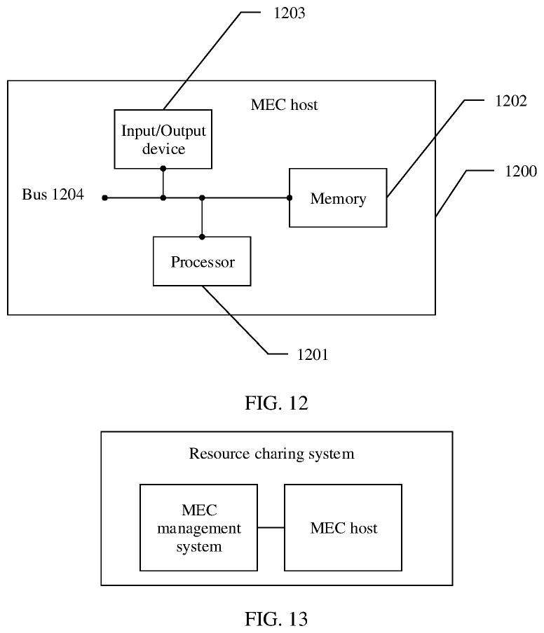

This application further provides a MEC host 1200. FIG. 12 shows an embodiment of a MEC management system according to an embodiment of this application. The MEC host may be configured to perform steps performed by the MEC host in the embodiments shown in FIG. 2, FIG. 3, FIG. 4, FIG. 5, FIG. 6, FIG. 7, and FIG. 8. For details, refer to related description in the foregoing method embodiments.

The MEC host 1200 includes a processor 1201, a memory 1202, an input/output device 1203, and a bus 1204.

In a possible implementation, the processor 1201, the memory 1202, and the input/output device 1203 are separately connected to the bus 1204, and the memory stores computer instructions.

The processor 1201 is configured to execute the computer instructions, so that the MEC host performs related method steps performed by the MEC host in the foregoing method embodiments.

The processing module 1001 in the foregoing embodiment may be specifically the processor 1201 in this embodiment. Therefore, a specific implementation of the processor 1201 is not described again. The transceiver module 1002 in the foregoing embodiment may be specifically the input/output device 1203 in this embodiment.

Refer to FIG. 13. An embodiment of this application further provides a resource charging system. The resource charging system includes a MEC management system and a MEC host. Specifically, the MEC management system may include the MEC management system shown in FIG. 9 and the MEC host shown in FIG. 10. The MEC management system may be configured to perform all or some of steps performed by the MEC management system in the embodiments shown in FIG. 2, FIG. 3, FIG. 4, FIG. 5, FIG. 6, FIG. 7, and FIG. 8. The MEC host may be configured to perform all or some of steps performed by the MEC host in the embodiments shown in FIG. 2, FIG. 3, FIG. 4, FIG. 5, FIG. 6, FIG. 7, and FIG. 8.

It may be clearly understood by a person skilled in the art that, for a purpose of convenient and brief description, for detailed working processes of the foregoing system, apparatus, and unit, refer to corresponding processes in the foregoing method embodiments. Details are not described herein again.

In the several embodiments provided in this application, it should be understood that the disclosed system, apparatus, and method may be implemented in another manner. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one location, or may be distributed on a plurality of network units. A part or all of the units may be selected based on an actual requirement to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a computer-readable storage medium. Based on such an understanding, the technical solutions of this application essentially, or the part contributing to the current technology, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A method, comprising:
receiving, by a multi-access edge computing (MEC) management system, resource usage information of a tenant sent by a MEC host, wherein the resource usage information is about a resource consumed by a MEC application created by the tenant; and
sending, by the MEC management system, the resource usage information to a charging system device, wherein the resource usage information is used by the charging system device to charge the resource consumed by the MEC application of the tenant.

2. The method according to claim 1, wherein the resource usage information comprises a type of the resource, a size of the resource, a quantity of times of usage of the resource, usage duration of the resource, a usage start time of the resource, and a usage end time of the resource.

3. The method according to claim 1, wherein:
the type of the resource comprises a service resource or a system resource, the service resource comprises an application programming interface (API) that is provided by a MEC service and that is invoked by the MEC application, and the system resource comprises a computing resource, a network resource, or a storage resource consumed when the MEC application runs; and
the resource usage information comprises a quantity of times that the MEC application invokes the API provided by the MEC service, and the quantity of times that the MEC application invokes the API is used by the charging system device to calculate, based on a preset API usage rate, a charging amount of a service resource used by the tenant.

4. The method according to claim 1, further comprising:
before receiving, by the MEC management system, the resource usage information of the tenant sent by the MEC host, receiving, by the MEC management system, a charging policy of the tenant sent by a charging policy device; and
sending, by the MEC management system, an indication message to the MEC host, wherein the indication message carries the charging policy of the tenant.

5. The method according to claim 1, further comprising:
before receiving, by the MEC management system, the resource usage information of the tenant sent by the MEC host, obtaining, by the MEC management system, a charging policy of the tenant using an application instantiation request message of the tenant; and
sending, by the MEC management system, an indication message to the MEC host, wherein the indication message carries the charging policy of the tenant.

6. A method, comprising:
collecting, by a multi-access edge computing (MEC) host, resource usage information of a tenant, wherein the resource usage information is about a resource consumed by a MEC application created by the tenant; and
sending, by the MEC host, the resource usage information to a MEC management system, causing the MEC management system to send the resource usage information to a charging system device, wherein the charging system device charges a resource used by the tenant.

7. The method according to claim 6, wherein the resource usage information comprises a type of the resource, a size of the resource, a quantity of times of usage of the resource, usage duration of the resource, a usage start time of the resource, and a usage end time of the resource.

8. The method according to claim 6, wherein:
the type of the resource comprises a service resource or a system resource, the service resource comprises an application programming interface (API) that is provided by a MEC service and that is invoked by the MEC application, and the system resource comprises a computing resource, a network resource, or a storage resource consumed when the MEC application runs; and
the resource usage information comprises a quantity of times that the MEC application invokes the API provided by the MEC service, and the quantity of times that the MEC application invokes the API is used by the charging system device to calculate, based on a preset API usage rate, a charging amount of a service resource used by the tenant.

9. The method according to claim 6, further comprising:
before collecting, by the MEC host, the resource usage information of the tenant, receiving, by the MEC host, an indication message sent by the MEC management system, wherein the indication message carries a charging policy of the tenant, and the charging policy is used by the MEC host to report the resource usage information to the MEC management system.

10. The method according to claim 9, further comprising:
before sending, by the MEC host, the resource usage information to the MEC management system, receiving, by the MEC host, a first resource charging quota that the charging system device sets for the tenant and that is sent by the MEC management system, wherein the charging policy indicates an online charging mode, and the charging policy carries a usage rate of a resource used by the tenant;
calculating, by the MEC host, a resource charging amount of the tenant based on the resource usage information and the usage rate; and
comparing, by the MEC host, the resource charging amount with the first resource charging quota, to obtain a resource charging difference; and
wherein sending, by the MEC host, the resource usage information to the MEC management system comprises:
when the resource charging difference is less than or equal to a preset threshold, sending, by the MEC host, the resource usage information to the MEC management system.

11. The method according to claim 9, wherein the charging policy indicates an offline charging mode, the charging policy carries a period in which the MEC host reports the resource usage information, and sending, by the MEC host, the resource usage information to the MEC management system comprises:
sending, by the MEC host, the resource usage information to the MEC management system based on the period.

12. A system, comprising:
a multi-access edge computing (MEC) management system; and
a MEC host, configured to:
collect resource usage information of a tenant, wherein the resource usage information is about a resource consumed by a MEC application created by the tenant; and
send the resource usage information to the MEC management system; and
wherein the MEC management system is configured to:
receive the resource usage information; and
send the resource usage information to a charging system device, wherein the resource usage information is used by the charging system device to charge the resource consumed by the MEC application created by the tenant.

13. The system according to claim 12, wherein the resource usage information comprises a type of the resource, a size of the resource, a quantity of times of usage of the resource, usage duration of the resource, a usage start time of the resource, and a usage end time of the resource.

14. The system according to claim 12, wherein:
the type of the resource comprises a service resource or a system resource, the service resource comprises an application programming interface (API) that is provided by a MEC service and that is invoked by the MEC application, and the system resource comprises a computing resource, a network resource, or a storage resource consumed when the MEC application runs; and
the resource usage information comprises a quantity of times that the MEC application invokes the API provided by the MEC service, and the quantity of times that the MEC application invokes the API is used by the charging system device to calculate, based on a preset API usage rate, a charging amount of a service resource used by the tenant.

15. The system according to claim 12, wherein the MEC management system is further configured to:
receive a charging policy of the tenant sent by a charging policy device; and
send an indication message to the MEC host, wherein the indication message carries the charging policy of the tenant; and
wherein the MEC host is further configured to:
receive the indication message sent by the MEC management system, wherein the charging policy is used by the MEC host to report the resource usage information to the MEC management system.

16. The system according to claim 12, wherein the MEC management system is further configured to:
obtain a charging policy of the tenant by using an application instantiation request message of the tenant; and
send an indication message to the MEC host, wherein the indication message carries the charging policy of the tenant.
